(19) United States
(12) Patent Application Publication
(10) Pub. No.: US 2009/0165652 A1
(43) Pub. Date: Jul. 2, 2009

(54) PURIFICATION DEVICE FOR FLUE GASES

(75) Inventor: Guangliang Chen, Beijing (CN)

Correspondence Address: YING CHEN;Chen Yoshimura LLP, 255 S. GRAND AVE., # 215, LOS ANGELES, CA, 90012, US

(73) Assignee: Haisibote ( Beijing ) Science and Technology Co., Ltd., Beijing (CN)

(21) Appl. No.: 12/118,283

(22) Filed: May 9, 2008

(30) Foreign Application Priority Data
Dec. 28, 2007 (CN) 200710304602.6

(51) Int. Cl. B01D 53/18

(52) U.S. Cl. 96/122; 96/243; 96/262; 96/203

(57) ABSTRACT

The invention relates to a purification device for flue gases a purification device for flue gases comprising a primary purification tower, a washing tower and an adsorption tower which are connected in sequence. The washing tower is a spray tower and the adsorption tower includes a plurality of standard flashboards inserted into its flue gases duct. A plurality of washing nozzles are placed in a central part of an inner space of the spray tower, a plurality of sieve plates are placed in a lower part of an inner space of the spray tower and a gas-liquid segregating unit is placed in an upper part of an inner space of the spray tower. The device is simple in technique, convenient in operation and can completely remove the harmful ingredients from the flue gases, and thereby reducing the harm of flue gases upon human bodies and environment.

### BACKGROUND OF THE INVENTION

1. Field of the Invention

The invention relates to a purification device for flue gases.

2. Description of the Related Art

Flue gases contain not only dusts but also harmful ingredients of heavy metals and organic pollutants, which will exist in single-phase or be adsorbed onto surfaces of fine particles in the air and be great harmful to both human bodies and environment once discharged into the air. The existing purification devices for flue gases have lower efficiencies of removing harmful ingredients of low concentration.

### SUMMARY OF THE INVENTION

To overcome above defects in the prior art, the invention provides a purification device for flue gases, which is simple in technique, convenient in operation, compact in structure, small in floor space and low in cost and has a high efficiency of removing such harmful ingredients as traces of heavy metals and organic pollutants, etc. in the form of steam, fine single-phase particles and adsorbed state.

The technical solution of this invention to achieve above purposes is: a purification device for flue gases comprising a primary purification tower, a washing tower and an adsorption tower which are connected in sequence.

The main beneficial effects of the invention are: in the primary purification tower, most of flying ashes, sulfur dioxides and nitrogen oxides in flue gases are removed, bringing convenience for subsequent treatment and eliminating impacts of flying ashes on subsequent equipments. The washing tower will further remove residual flying ashes, sulfur dioxides and nitrogen oxides in flue gases, not only promoting the degree of purification of relative pollutants, but also eliminating the impacts on subsequent adsorbing materials for that the adsorbing materials are sensitive to flying ashes and colloids. A thorough purification of flying ashes is a principal factor for increasing the service life of the subsequent adsorbing materials. The adsorption tower is treat other residual ingredients for adsorption is basically effectual towards various harmful ingredients in flue gases with high degree of purification, and thereby realizing complete purification of harmful ingredients in flue gases and eliminating pollutions caused by flue gases on the atmosphere. In addition, the method of the invention is simple in technique and convenient in operation. The primary purification of dust removing, desulphurizing and denitrating is available in prior art. Moreover, washing agents can be appropriately added in washing water to remove special harmful ingredients. The adsorption device has a compact structure and can be installed on current device to reduce investment and operating costs.

### BRIEF DESCRIPTION OF THE DRAWINGS

FIG. 1 is a schematic view of the purification device according to an embodiment of the present invention;

FIG. 2 is a schematic view of the washing tower of the purification device; and

FIG. 3 is a schematic view of the adsorption tower of the purification device.

### DETAILED DESCRIPTION OF THE PREFERRED EMBODIMENTS

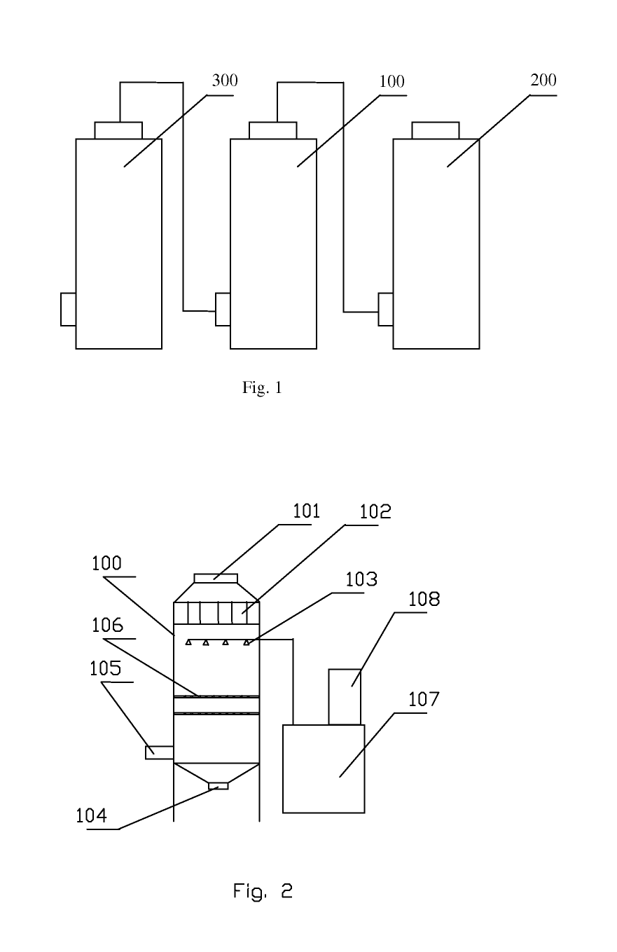

Refer to FIG. 1, this purification device comprises a primary purification tower 300, a washing tower 100 and an adsorption tower 200 which are connected in sequence.

Refer to FIG. 2, the washing tower can be a spray tower. The central part of the inner space of the spray tower is provided with a plurality of washing nozzles 103. The lower part of the inner space of the spray tower is provided with one or more sieve plates 106. The upper part of the inner space of the spray tower is provided with a gas-liquid segregating unit 102. Moreover, the admitting port 105 of the tower is connected with the inner space of the tower on the lower part of the sieve plate, and the vent port 101 is connected with the air-outlet end of the gas-liquid segregating unit. The outlet conduit of the fluid reservoir 107 is connected with the water supply conduit of the nozzles. The number of the sieve plates is one or two normally. The nozzles are evenly distributed on the cross section of the inner space of the tower. The gas-liquid segregating unit comprises a plurality of folded plates and the delivery port of the spray tower is located on one side of the lower below the sieve plates. The drain hole 104 is arranged at the bottom of the spray tower.

In terms of the nature of harmful ingredients in flue gases, relative absorbing agents can be added to the washing solvent. Moreover, the fluid reservoir can be provided with the feeding device 108, which equipped on the washing tower to add the absorbing agents into the washer solvent.

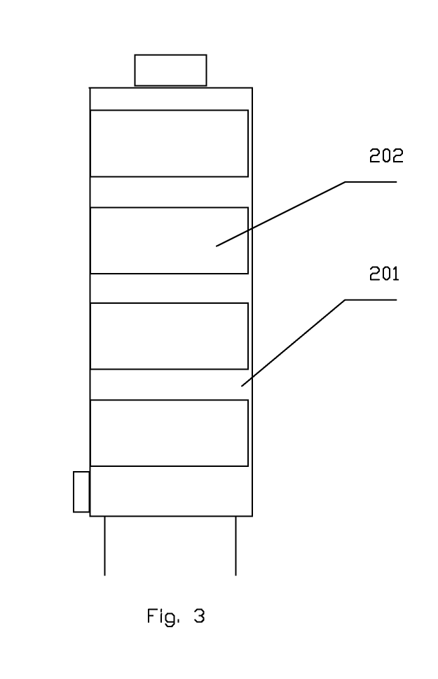

Refer to FIG. 3, the adsorption tower is of a flashboard structure with a plurality of standard flashboards 202. The a plurality of standard flashboards 202 are made of various adsorbing materials and inserted into the flue gases duct 201 to realize the adsorption of flue gases. The adsorbing materials can be selected in terms of characteristics of harmful ingredients in flue gases, such as active carbon materials, rare-earth materials, iron flying ashes, and zeolites, etc. reproducible or changeable for reuse. Therefore, the adsorbing materials can match with each other for adsorbing various harmful ingredients to ensure that such harmful ingredients as residual traces of heavy metals and organic pollutants, etc. in the form of steam state, single-phase fine particles and adsorbed state, etc. be efficiently removed.

It will be apparent to those skilled in the art that various modification and variations can be made in the device of the present invention without departing from the spirit or scope of the invention. Thus, it is intended that the present invention cover modifications and variations that come within the scope of the appended claims and their equivalents.

What is claimed is:

1. A purification device for flue gases, comprising a primary purification tower, a washing tower and an adsorption tower connected in sequence.

2. A device of claim 1, wherein the washing tower is a spray tower.

3. A device of claim 2, wherein the spray tower includes a plurality of washing nozzles placed in a central part of an inner space of the spray tower.

4. A device of claim 3, wherein the spray tower further includes a plurality of sieve plates placed in a lower part of the inner space of the spray tower.

5. A device of claim 4, wherein the spray tower further includes a gas-liquid segregating unit placed in an upper part of the inner space of the spray tower.

6. A device of claim 5, wherein the spray tower further includes an admitting port connected to the inner space of the spray tower on a lower part of the sieve plates and a vent port connected to an air-outlet end of the gas-liquid segregating unit.

7. A device of claim 6, wherein the washing nozzles are evenly distributed on a cross section of the inner space of the spray tower.

8. A device of claim 7, wherein the gas-liquid segregating unit includes a plurality of folded plates.

9. A device of claim 8, wherein the spray tower further includes a delivery port located on a side of the spray tower below the sieve plates.

10. A device of claim 9, wherein the spray tower further includes a drain hole placed at a bottom of the spray tower.

11. A device of claim 10, further comprising a fluid reservoir, wherein an outlet conduit of the fluid reservoir is connected with a water supply conduit of the nozzles.

12. A device of claim 11, wherein the fluid reservoir includes a feeding device.

13. A device of claim 1, wherein the adsorption tower includes a plurality of standard flashboards inserted into its flue gases duct.

14. A device of claim 3, wherein the adsorption tower includes a plurality of standard flashboards inserted into its flue gases duct

15. A device of claim 5, wherein the adsorption tower includes a plurality of standard flashboards inserted into its flue gases duct.

16. A device of claim 7, wherein the adsorption tower includes a plurality of standard flashboards inserted into its flue gases duct.

17. A device of claim 9, wherein the adsorption tower includes a plurality of standard flashboards inserted into its flue gases duct.

18. A device of claim 10, wherein the adsorption tower includes a plurality of standard flashboards inserted into its flue gases duct.

19. A device of claim 11, wherein the adsorption tower includes a plurality of standard flashboards inserted into its flue gases duct.

20. A device of claim 12, wherein the adsorption tower includes a plurality of standard flashboards inserted into its flue gases duct.
